(19) United States
(12) Patent Application Publication
(10) Pub. No.: US 2006/0109200 A1
(43) Pub. Date: May 25, 2006

(54) Rotating cylinder multi-program and auto-stereoscopic 3D display and camera

(76) Inventor: Ray M. Alden, Raleigh, NC (US)

Correspondence Address: Ray M. Alden, 808 Lake Brandon Trail, Raleigh, NC, 27610, US

(21) Appl. No.: 11/156,403

(22) Filed: Jun. 20, 2005

Related U.S. Application Data
(63) Continuation-in-part of application No. 10/994,556, filed on Nov. 22, 2004.
(63) Continuation-in-part of application No. 11/050,619, filed on Feb. 2, 2005.
(63) Continuation-in-part of application No. 11/095,403, filed on Mar. 31, 2005.

(51) Int. Cl. G09G 5/00

(52) U.S. Cl. 345/8

(57) ABSTRACT

The invention described herein represents a significant improvement for the users of displays. In a first reflective immersive embodiment, a rotating encompassing projection screen with integral horizontal and vertical reflective lenticulars completely surrounds users to enable multiple users to concurrently watch completely different programs including auto-stereoscopic 3D programs in an immersive venue format which is highly reliable and cheap to produce. In a second transmissive immersive embodiment, a rotating encompassing projection screen with integral horizontal and vertical transmissive lenticulars completely surrounds users to enable multiple users to concurrently watch completely different programs including auto-stereoscopic 3D programs in an immersive venue format which is highly reliable and cheap to produce. In a third embodiment, a rotating projection screen with integral horizontal and vertical reflective lenticulars enables multiple users to concurrently watch completely different programs including auto-stereoscopic 3D programs in a front projection format which is highly reliable and cheap to produce. In a fourth embodiment, a rotating projection screen with integral horizontal and vertical transmissive lenticulars enables multiple users to concurrently watch completely different programs including auto-stereoscopic 3D programs in a rear projection format which is highly reliable and cheap to produce. Also in recording embodiments, a camera replaces the projector in each respective embodiment to enable recording of auto-stereoscopic 3D scenes.

### CROSS-REFERENCE TO RELATED APPLICATIONS

This application is a continuation in part of the following patent applications by the present applicant; U.S. application Ser. No. 10/994,556 filed Nov. 22, 2004, U.S. application Ser. No. 11/050,619 filed Feb. 2, 2005, and U.S. application Ser. No. 11/095,403 filed Mar. 31, 2005.

### BACKGROUND

1. Field of Invention

Modern video display devices incorporate many technologies and methods for providing high quality video to users. Nearly every household in the United States has one or more video displays in the form of a television or a computer monitor. These devices generally use technologies such as Cathode Ray Tubes (CRT) tubes, FEDs, Liquid Crystal Displays (LCD), OLEDs, Plasma, Lasers, LCoS, Digital Micromirror Devices (DMD), front projection, rear projection, or direct view in one way or another. Large monitors offer the advantage of enabling many users to see the video monitor simultaneously as in a living room television application for example. Often video users do not want to view the same image streams as one another. Instead viewers would often like to see completely different programs or image streams at the same time. Alternately viewers would like to see the same program in 3D (three-dimensional) format. Moreover, people would like to enjoy high resolution images on their video monitors.

The present invention provides a significant step forward for video displays. The present invention describes display architectures that can be used with many display technologies together with specific implementations including a projector based pixel engine with an actuated reflective lenticular screen and a direct view based pixel engine with an actuated transmissive screen. The art described herein is suitable for enhancing the performance of many image generators including Cathode Ray Tubes (CRT) tubes, FEDs, Liquid Crystal Displays (LCD), OLEDs, Plasma, Lasers, LCoS, and Digital Micromirror Devices (DMD), and in front projection, rear projection, or direct view applications.

2. Description of Prior Invention

The prior art describes some attempts to enable multiple viewers to see different video streams concurrently on the same monitor. Many are generally drawn to wearing glasses that use polarization or light shutters to filter out the unwanted video stream while enabling the desired video stream to pass to the users' eyes. U.S. Pat. No. 6,188,442 Narayanaswami being one such patent wherein the users wear special glssses to see their respective video streams. U.S. Pat. No. 2,832,821 DuMont does provide a device that enables two viewers to see multiple polarized images from the same polarizing optic concurrently. DuMont however also requires that the viewers use separate polarizing screens as portable viewing aids similar to the glasses. DuMont further requires the expense of using two monitors concurrently. Japanese patent JP409105909A, Yamazaki et al describes a stationary lenticular array as the means to enable multiple program viewing, however the approach requires a corresponding diminution of resolution in direct relationship with the number of programs displayed concurrently. No known prior art provides a technique to enable multiple viewers to view separate video streams and watch auto stereoscopic 3D programs on a display without a diminution of resolution

The so called “Cambridge Display” or “Travis Display” provides a well publicized means for using time sequential spatially multiplexed viewing zones as a method to enable multiple viewers to see auto-stereoscopic 3-D images on a display. This technique is described in U.S. Pat. No. 5,132,839 Travis 1992, U.S. Pat. No. 6,115,059 Son et al 2000, and U.S. Pat. No. 6,533,420 Eichenlaub 2003. The technique is also described in other documents including; “A time sequenced multi-projector auto-stereoscopic display”, Dodgson et al, Journal of the Society for Information Display 8(2), 2000, pp 169-176; “A 50 inch time-multiplexed auto-stereoscopic display” Proceedings SPIE Vol 3957, 24-26 Jan. 2000, San Jose Calif., Dodgson, N. A., et al.; Proceedings SPIE Vol 2653, Jan. 28-Feb. 2, 1996, San Jose, Calif., Moore, J. R., et al.; and can be viewed at http://www.cl.cam.ac.uk/Research/Rainbow/projects/asd.html. This prior art typically relies on optics to first compress the entire image from a pixel generator such as a CRT tube, secondly an optical element such as a shutter operates as a moving aperture that selects which orientation of the entire compressed image can pass therethrough, thirdly, additional optics magnify the entire image, and fourthly the image is presented to a portion of viewer space. This process is repeated at a rate of approximately 60 hertz with the shutter mechanism operating in sync with the pixel generator to present different 3D views to different respective portions of viewer space. Two main disadvantages of this prior art are easily observable when viewing their prototypes. A first disadvantage is that a large distance on the order of feet is required between the first set of optics and the steering means, and between the steering means and the second set of optics. This disadvantage results in a display that is far too bulky for consumer markets or for any flat panel display embodiments. Secondly, looking at the display through large distances between optics creates a tunnel effect that tends to diminish the apparent viewable surface area of the resultant viewing screen.

According to Deep Light of Hollywood, Calif., the intellectual property comprising the “Cambridge display” is owned and being advanced by Deep Light. Also Physical Optics Corporation describes on their website that they are currently building a prototype of a time sequenced 3D display using liquid crystal beam steering at the pixel level similarly to that which has been described by the present applicant in previous applications.

Also Hewlett Packard has announced a “wobleation” process that physically moves a DLP image generator having a first resolution through a tiny position cycle in sync with driving it to produce every alternate pixel at a faster generation rate with the result being a higher second resolution image being projected on a diffuse surface. Increasing resolution using this methodology requires optics to manipulate the image at the sub pixel level or alternately, larger distances between pixel at the chip level, thus the actuation of the DLP chip approach to increasing resolution is not easily upgradeable without substantial cost to a user. Also, the method developed by HP requires a predefinition of what the maximum resolution of the display will be.

By contrast the present invention describes a rotatable reflective lenticular or transmissive lenticular where the lenticular circumference is equal to the number of perspectives generated in the 3D application times the width of an individual pixel. The lenticular is then rotated on an axis that is perpendicular to the image in single pixel width increments. In the multiple program application, the lenticular is rotated on an axis perpendicular to the image a minimum distance of one lenticular width divided by the number of programs presented concurrently. Embodiments relying upon a reflective screen and a transmissive optic are described. Also embodiments comprise a dome shaped screen and a cylinder shaped screen are described. The present invention also can increase the resolution of the image by producing images at higher speeds and rotating the lenticular in increments of less than one pixel width.

The present invention provides integration of multiple image perspectives and/or multiple programs in a novel manner and the presentation of the images to multiple viewers. The system provides a display for enabling multiple users to watch multiple 2-D or 3-D programs on the same display at the same time, full screen and full resolution.

Other relevant disclosures have been made by the present applicant including those cited at the beginning of this document which are incorporated herein by reference.

### BRIEF SUMMARY

The invention described herein represents a significant improvement for the users of displays. In a first reflective immersive embodiment, a rotating encompassing projection screen with integral horizontal and vertical reflective lenticulars completely surrounds users to enable multiple users to concurrently watch completely different programs including auto-stereoscopic 3D programs in an immersive venue format which is highly reliable and cheap to produce. In a second transmissive immersive embodiment, a rotating encompassing projection screen with integral horizontal and vertical transmissive lenticulars completely surrounds users to enable multiple users to concurrently watch completely different programs including auto-stereoscopic 3D programs in an immersive venue format which is highly reliable and cheap to produce. In a third embodiment, a rotating projection screen with integral horizontal and vertical reflective lenticulars enables multiple users to concurrently watch completely different programs including auto-stereoscopic 3D programs in a front projection format which is highly reliable and cheap to produce. In a fourth embodiment, a rotating projection screen with integral horizontal and vertical transmissive lenticulars enables multiple users to concurrently watch completely different programs including auto-stereoscopic 3D programs in a rear projection format which is highly reliable and cheap to produce.

Also in recording embodiments, a camera replaces the projector in each respective embodiment to enable recording of auto-stereoscopic 3D scenes.

Thus the present invention offers a significant advancement in display and camera functionality. For which large markets are contemplated.

### OBJECTS AND ADVANTAGES

Accordingly, several objects and advantages of the present invention are apparent. It is an object of the present invention to provide an image display means which enables multiple viewers to experience completely different video streams simultaneously. This enables families to spend more time together while simultaneously independently experiencing different visual media or while working on different projects in the presence of one another or alternately to concurrently experience auto stereoscopic 3D media with their unaided eyes. Also, electrical energy can be saved by concentrating visible light energy from a display into narrower user space where a user is positioned. Likewise when multiple users use the same display instead of going into a different room, less electric lighting is required. Also, by enabling one display to operate as multiple displays, living space can be conserved which would otherwise be cluttered with a multitude of displays.

It is an advantage that the present invention doesn't require special eyewear, eyeglasses, goggles, or portable viewing devices as does the prior art.

It is an advantage of the present invention that the same monitor that presents multiple positionally segmented image streams also can provide true positionally segmented auto stereoscopic 3D images as well as stereoscopic images as well as standard 2D images.

It is an advantage of the present invention that one or more users can experience immersive auto-stereoscopic 3D video images or multiple concurrent video streams from inside a rotating dome, cylinder, conic section, or another shape conducive of being rotated. It is an advantage of the present invention that one or more users can experience auto-stereoscopic 3D video images or multiple concurrent video streams from outside of a rotating dome, cylinder, conic section, or another shape conducive of being rotated.

It is an advantage of the present invention that a rotating screen is described which rotates around an axis that is either perpendicular to the viewing angle or which is parallel to the viewing axis or is otherwise positioned for optimal viewing.

IT is an object of the present invention to provide an auto-stereoscopic 3D camera for recording immersive video.

It is an advantage that both the reflective lenticular screen and the transmissive lenticular reflecting screen are cheap to produce and very reliable.

Further objects and advantages will become apparent from the enclosed figures and specifications.

### DRAWING FIGURES

FIG. 1a illustrates a user immersed inside a rotating dome projection screen.

FIG. 1b illustrates the dome of FIG. 1a advanced in a rotation.

FIG. 2 illustrates pixel reflection from a lenticular wide section of the dome of FIG. 1a and FIG. 1b.

FIG. 3a illustrates multiple pixels reflected from the lenticular of FIG. 2.

FIG. 3b illustrates a top view of a stepped lenticular configuration.

FIG. 3c illustrates the pixel map of two adjacent lenticulars on a rotating display screen.

FIG. 3d illustrates a smooth lenticular configuration.

FIG. 4a illustrates a several pixel tall and two pixel wide segment of a rotating lenticular screen pixel map.

FIG. 4b is the pixel map in the same location as FIG. 4a after the rotating lenticular screen is advanced.

FIG. 5 illustrate a section of reflective lenticular rotating 3D pixel array.

FIG. 6 illustrates the lenticular positioning of a 3D auto stereoscopic rotating dome screen.

FIG. 7 illustrates a the effective auto-stereoscopic viewing zone assuming 20 pixels per lenticular each reflected 3 degrees wide.

FIG. 8a illustrates a second embodiment of a rotating lenticular dome comprising a transmissive steering array with a user on the outside of the dome.

FIG. 8b illustrates the system of FIG. 8a rotationally advanced at a subsequent time.

FIG. 9a illustrates a third embodiment of a rotating lenticular dome comprising a transmissive steering array with a user on the inside of the dome.

FIG. 9b illustrates the system of FIG. 9a rotationally advanced at a subsequent time.

FIG. 10a illustrates a fourth embodiment of a rotating lenticular dome comprising a reflective steering array with a user on the outside of the dome.

FIG. 10b illustrates the system of FIG. 8a rotationally advanced at a subsequent time.

FIG. 11 illustrates a cylindrically shaped rotating pixel steering array which can be substituted for the domes described in previous Figures.

FIG. 12 illustrates a non-diffusing transmissive lenticular in combination with a light filter.

FIG. 13 illustrates a light diffusing cylinder surface in combination with a light filter.

FIG. 14 illustrates multiple users interacting with an auto stereoscopic 3D and multiple program display.

FIG. 15a illustrates a rotating transmissive lenticular array steering light from a light emitting array and viewable from inside the lenticular cylinder.

FIG. 15b illustrates the rotating transmissive lenticular array steering of FIG. 15a in operation.

FIG. 15c illustrates a rotating transmissive lenticular array steering light from a light emitting array and viewable from outside the lenticular cylinder.

FIG. 15d illustrates the rotating transmissive lenticular array steering of FIG. 15c in operation

### DETAILED DESCRIPTION OF THE INVENTION

U.S. patent application Ser. No. 11/095,403 filed Mar. 31, 2005 by the present applicant comprises a rotating lenticular array for auto stereoscopic image creation and is incorporated herein by reference. U.S. patent application Ser. No. 11/050,619 filed Feb. 2, 2005 by the present applicant describes the manufacturing of a lenticular screen having pixel steering horizontal and vertical curvature properties and is incorporated herein by reference. U.S. patent application Ser. No. 10/994,556 filed Nov. 22, 2004 by the present applicant comprises an actuated lenticular array display screen and camera and is incorporated herein by reference.

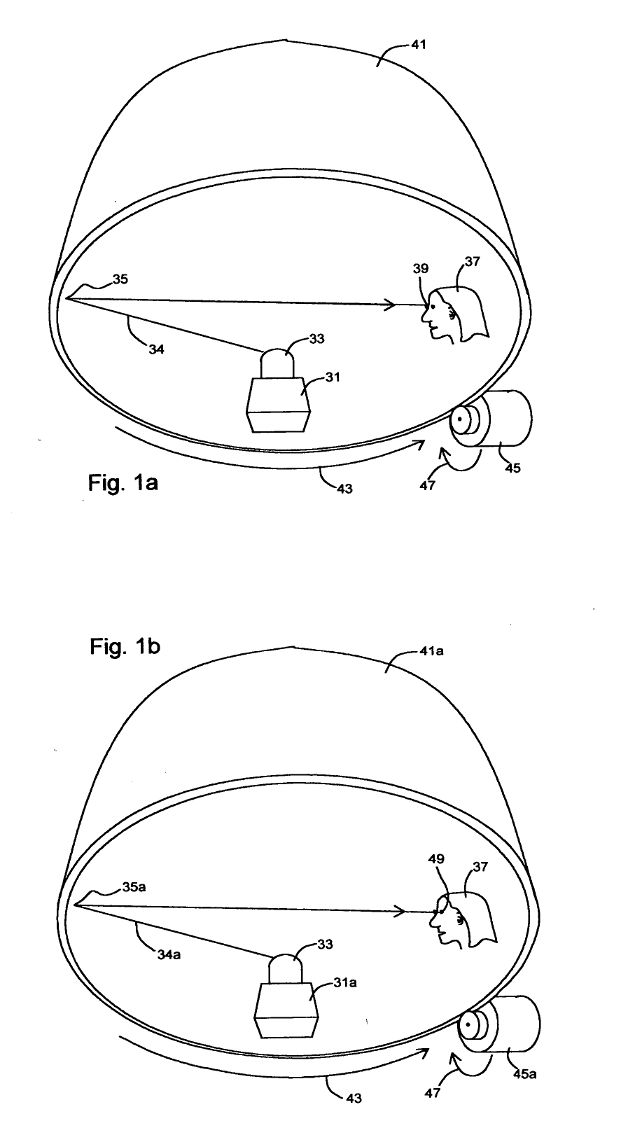

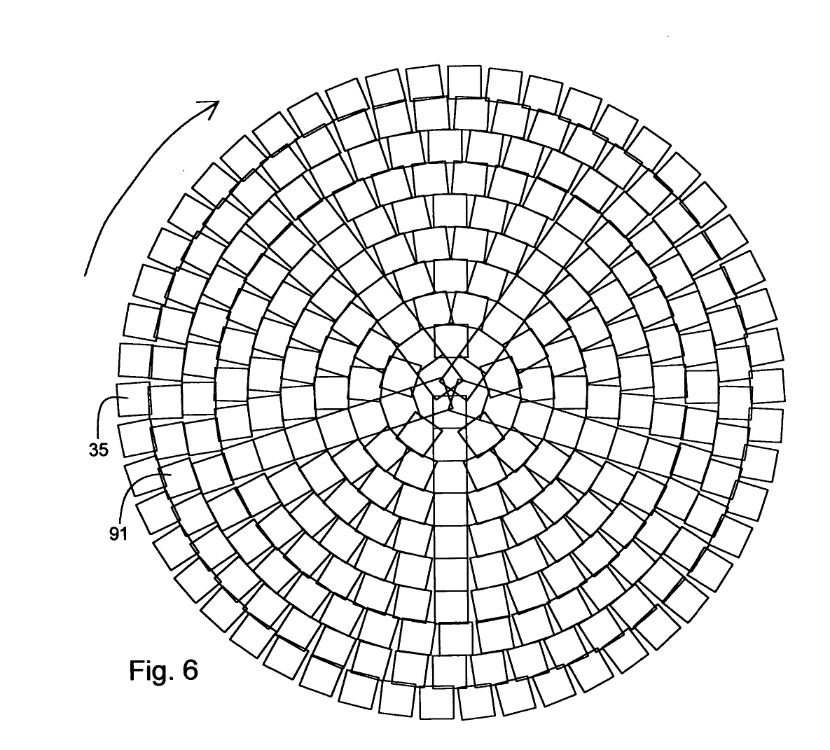

FIG. 1a illustrates a user immersed inside a rotating dome projection screen. A first rotating dome at a first instance in time 41 is a geometric structure manufactured to maintain a geometric shape comprising an interior and exterior. In the embodiment of FIG. 1, a first user at a first instance in time 37 sees an image inside the geometric curtain of the first rotating dome. The curtain as used herein is meant to be a position within or below the bottom circumference of the rotating geometric structure. As will be described, the image is directed from and is observable within the curtain of the first dome such that a first projector at a first instance in time 31 and the first user 37 are either inside or under the dome during operation. The projector and lens comprising an image producer. Similarly shaped static (non-rotating) dome shaped projection screen structures are produced by Elumens of Durham, N.C. wherein the shape of the inner dome is created by draping an air pervious flexible fabric bag around a rigid dome frame and creating a vacuum within the fabric bag such that it conforms to the shape of the frame structure. This methodology of dome creation can be used herein but molding of a rigid plastic structure is preferred. This rigid plastic structure being more easily rotatable as described herein and also enabling higher fidelity rigid light steering elements such as lenticulars and/or filters described herein. The first rotating dome geometric structure is caused to rotatably engage with a motor 45 which has a motor rotation 47 that causes a dome rotation 43. The dome's revolutions per minute are a function of the lowest number of steering lenticulars, as later described in FIG. 6, that are in the horizontal circumference of the dome such that 60 lenticulars pass by each pixel each second so as to steer respective pixels to be periodically directed to each portion of user space at a rate of 60 hertz. For example, assuming that the inner circumference surface of the first rotating dome comprises 120 lenticular steering elements in a horizontal plane and at a given instance in time, 10 pixels are incident upon each lenticular. Each of the 10 pixels needs to be steered across 10 different portions of user space at a rate of 60 hertz. Each time a single lenticular passes by an individual pixel, the moving lenticular causes the pixel to be swept across (turned on and off in) each of 10 respective user viewing spaces. Therefore, in order for the pixel to be turned on and off in each respective section of user space at a rate of 60 hertz, 60 lenticulars must pass by the pixel each second. Thus the dome must rotate at 60 lenticulars per second/120 lenticulars or 0.5 times per second which equates to the dome rotating at a rate of 30 RPMs. At 30 RPMs, a user viewing an image inside the dome will be fully immersed in an auto stereoscopic 3D image stream, or alternately in 3D stereoscopic video or in a 2D image content steam.

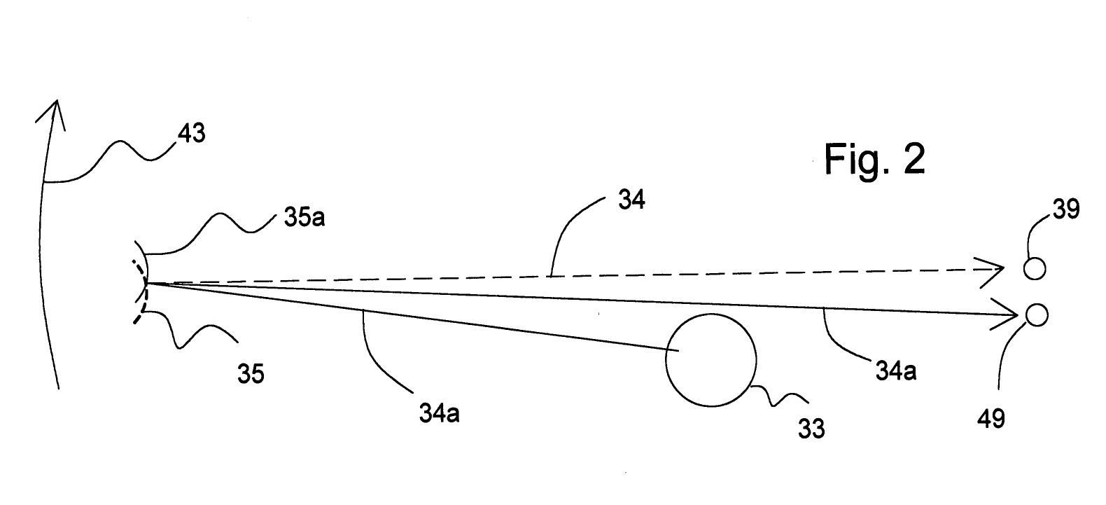

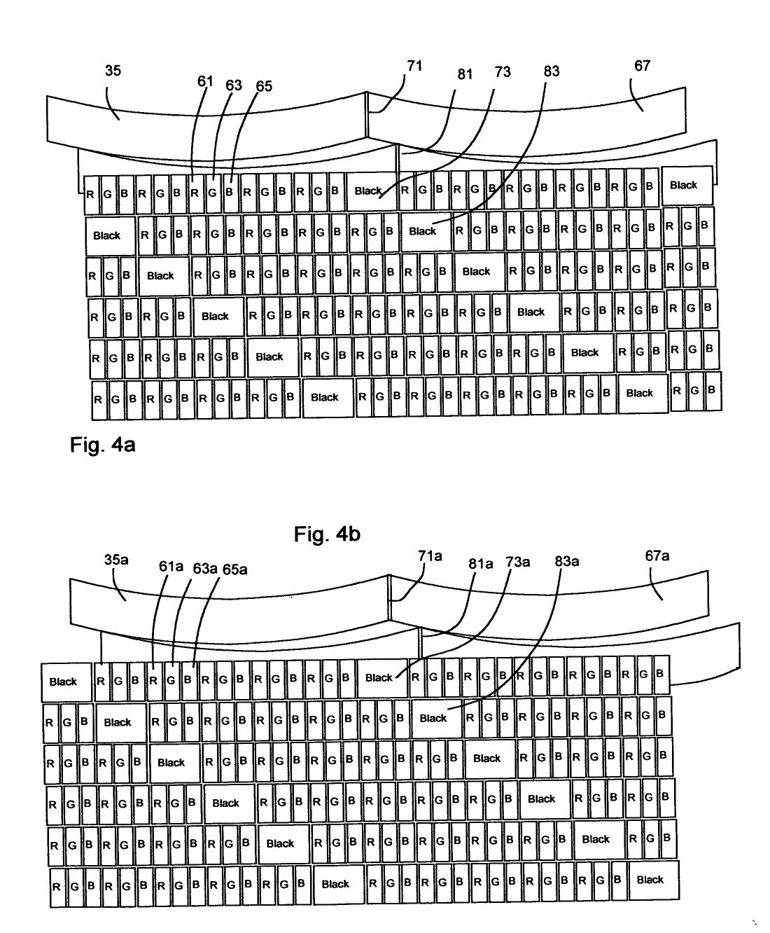

The first projector comprises a high speed DLP projector such as has been demonstrated by companies such as Actuality, Vizta3D, LightSpace, and DeepLight. Assuming that the production of ten perspectives is required to create an auto stereoscopic 3D immersive environment within the dome, a single projector generating images at 600 hertz is required. Using a 3 chip DLP projector and trading off some color resolution, projection of full pixel resolution images at rates of 600 hertz or greater have been demonstrated. Alternately, multiple projectors can be used without sacrificing color resolution to achieve 600 hertz and greater image creation rates. A first projection lens 33 is of a type produced by Elumens for the purpose of spreading an image from a projector to fit upon a dome structure. The first projection lens is commonly used with “SPI” software also sold by Elumens to transform an image for projection onto a dome. In operation, the first projector emits a first pixel on a first trajectory at a first instance in time 34. The first pixel at a first instance is incident upon a first portion of a first lenticular at a first instance in a first position 35 and reflected to a first portion of user space including into the right eye of the first user 39. The properties of the first lenticular and reflection there from is further described in FIGS. 2, 3a, 4a, 5, 6, and 7. Similar lenticular structures have also been described in previous applications by the present applicant referenced herein. Also the first pixel at a first instance 34 is one pixel representative of a portion of a first 3D perspective or alternately of a first 2D program. Many similar pixels are produced by the first projector at the first instance and reflected from many other lenticulars comprising the inner surface of the first rotating dome 41. A portion of the pixels illustrated in the pixel maps of FIGS. 4a and 4b.

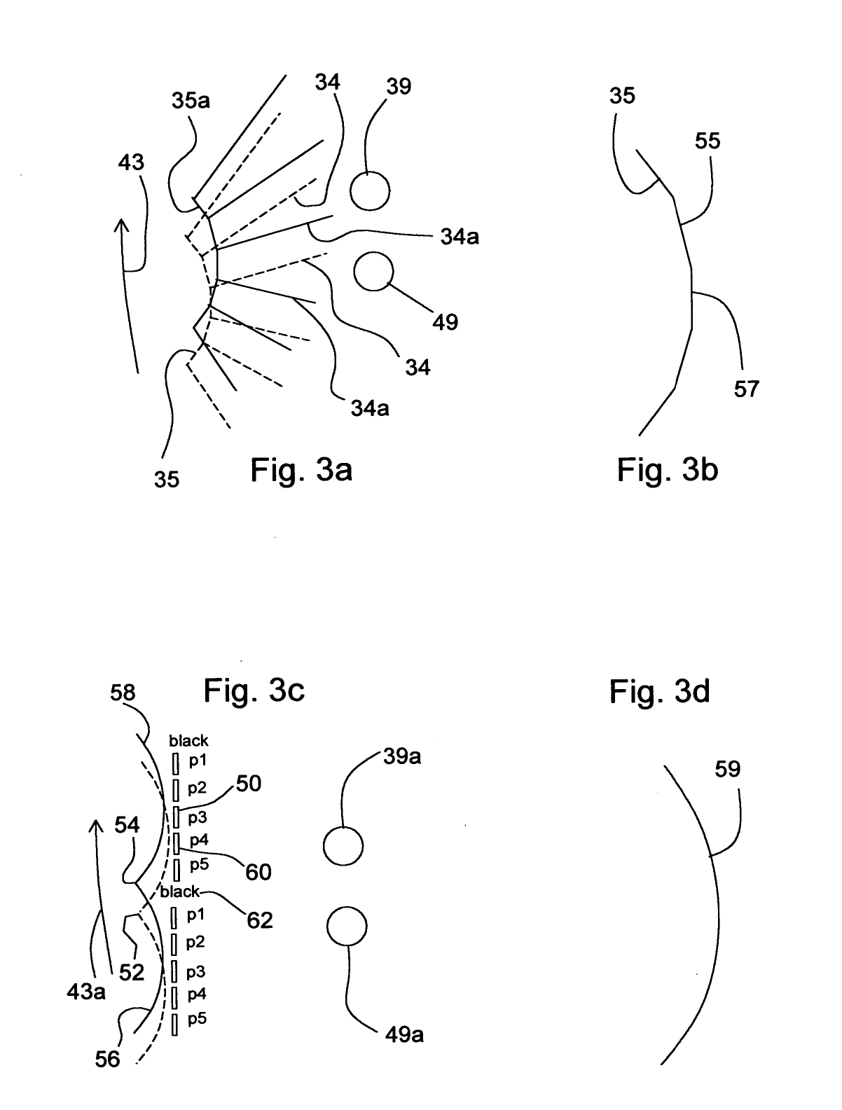

FIG. 1b illustrates the dome of FIG. 1a advanced in a rotation. A first projector at a second instance in time 31a emits a first pixel on a first trajectory at a second instance in time 34a Note that the trajectories of the first pixel at first instance 34 and the first pixel at second instance 34a are identical. Due to the advancement of a first motor at a second instance in time 45a, a first dome at a second instance in time 41a has been rotated a distance of one pixel width such that a first lenticular at a second instance in time 35a has been advanced such that the first pixel at a second instance in time is reflected to a second segment of user space which includes a left eye of the first user 49. The light in the first pixel at a second instance of time is representative of a second 3D perspective or alternately of the identical pixel of the first 2D program of FIG. 1a As will be described later FIGS. 3a, 3b, 3c, and 3d, the motor of FIGS. 1a and 1b and ensuing. Figures can be a stepper type that advance in increments equivalent to advancing the done by one pixel width increments or alternately, the motor can be continuous motion some differences between each type of motor are discussed later. Thus, and as further described in FIG. 2, from a single pixel, at slightly successive instances in time, the first user observers a first perspective with her right eye and a second perspective with her left eye. Every pixel in the entire dome similarly addresses multiple perspectives throughout the dome such that the user's right eye and left eye perceive different perspectives at slightly successive instances in time and thereby perceives a full auto stereoscopic 3D immersive environment. Any number of additional users within the dome concurrently will similarly experience a position dependent auto stereoscopic 3D immersive environment.

FIG. 2 illustrates a top view of pixel reflection from a lenticular wide section of the dome of FIG. 1a and FIG. 1b assume only 5 3D image perspectives are being projected which entails pixels being incident upon each lenticular a any given point in time. The first lenticular at the first instance in time 35 receives incident pixel light from the first pixel at a first instance in time 34 which it reflects to the first user's right eye 39. The first lenticular at the second instance in time 35a receives incident pixel light from the first pixel at a second instance in time 34a which it reflects to the first user's left eye 49. The dome rotation motion 43 having advance one pixel width. In practice, five, ten, or more pixels can be incident upon each respective rotating lenticular at each respective instance in time; the number of pixels incident upon each lenticular equal to the number of 3D perspectives that are presented by the display. The individual lenticular along with many others embossed into the rigid plastic dome as part of an extrusion or molding process and then having a reflected mirror surface deposited thereon; similar manufacturing and assembly processes having been also described in the previous patent applications referenced above and incorporated herein by reference. Also each lenticular has a vertical curvature or surface feature to ensure light is distributed across a wide vertical range while also having a horizontal curvature or surface feature to ensure that light of each individual pixel at a respective individual instance in time is distributed across a narrow horizontal range such as 2 or 3 degrees wide; the curvatures and surface features having been described in the applications of the present applicant which have been previously referenced and incorporated herein by reference. Vertical curvature of lenticulars can be shaped to prevent cross talk from lenticulars on opposite sides of the dome by being curved such that they reflect light out the bottom of the dome instead of toward opposing sides of the dome and whereby the user is below the bottom of the dome.

FIG. 3a illustrates a top view of multiple pixels reflected from the lenticular of FIG. 2. At the first instance in time the first 34 pixel is spread throughout a narrow horizontal range of user space including the first user's right eye. At the second instance in time the first 34a pixel is spread throughout a narrow horizontal range of user space including the first user's left eye. The first pixel at a first instance in time being representative of an xth pixel in an image from a first 3D perspective of a 3D image and the first pixel at a second instance in time being representative of the xth pixel in a second 3D perspective of a 3D image which is rotated 3 degrees compared to the first 3D perspective of a 3D image. Thus the first user's right and left eyes respectively see different light from the same pixel which when combined with many similar multiple perspectives from many pixels, the users brain perceives as a 3D image. This figure depicts clean lines between the first pixel at the first instance and the first pixel at the second instance relative to adjoining pixels which can be achieved by using a stepper motor to advance the dome by one pixel width increments between presentation of the distinct instances in time. This together with calculated curvature of the lenticular as has been previously described in the present applicant's prior applications enable clean lines between perspectives. Of course in practice across the interior surface of the dome each user will see pixels from a multitude of more than two perspectives the combination of perspectives being dependent upon their respective physical viewing positions and with high resolution 3D, even a slight change in position will yield a change in perspective from some multitude of lenticulars further enhancing the auto-stereoscopic effect.

FIG. 3b illustrates a top view of a stepped lenticular configuration. A first segment of the first lenticular 55 has a first angle and a second segment of the first lenticular 57 has a second angle. The angle of the lenticular upon which a pixel is incident determines the segment of user space to which it is directed. Segments of the lenticular can be flat or curved depending upon the pixel divergence produced by the projection lens 33 and the rotational resolution between different 3D perspectives.

FIG. 3c illustrates the pixel map of two adjacent lenticulars on a rotating display screen. Different 3D perspectives are represented by p1, p2, p3, p4, and p5. While each lenticular is shown to received 5 pixels/perspectives, in practice ten or more perspectives will actually be utilized to achieve higher 3D resolution. A first curved lenticular 58 is an alternate to the lenticular with distinct segments. When curved lenticulars are used in conjunction with a continuous motion actuation motor, the adjoining perspectives will blend with one another. For example, whereas the first user's left eye 39 received light from a single perspective in FIG. 3a, an alternate first user's left eye 39a will receive a combination of light from two perspectives as the alternate continuous rotation 43a advances and perspectives are presented during the first and second instances in time. This blending of perspectives can give a smoother view the only caveat being where the first curved lenticular 58 meets a second curved lenticular 56 at lenticular joint 54. A black pixel needs to appear at the joints of the lenticular so that perspectives at the extreme of the display's range do not blend together. Therefore a first black pixel 62 remains over the first lenticular joint 54 such that light from p5 and light from p1 do not blend together. The black pixel having previously been directed to the previous lenticular joint 52.

FIG. 3d illustrates a top view of an exemplary smooth lenticular 59 configuration and it is provided to contrast with the segmented lenticular of FIG. 3b.

FIG. 4a illustrates a several pixel tall and two pixel wide segment of a rotating lenticular screen pixel map. In practice, the pixel map will completely engulf the dome and FIGS. 4a and 4b represent a very small fraction of the pixels that are incident upon the dome. The first reflecting lenticular at the first time instance 35 is embedded into the dome surface next to a second reflecting lenticular at a first instance in time 67. These lenticulars meet at a first reflecting lenticular joint 71 and the pixel map comprises a black segment 73 that is incident upon the first reflecting lenticular joint 71 such that no perspective blending occurs between the right most and left most 3D perspectives. The first pixel at first time instance 34 of FIG. 4a comprises constituent colors first red sub pixel 61, first green sub pixel 63, and first blue sub pixel 65. A row of reflecting lenticulars resides below the first lenticular at first time instance 35 but is offset by one pixel width such that a second reflecting lenticular joint 81 does not line up vertically with the first reflecting lenticular joint 71. Rows of lenticulars do not line up so as to ensure that viewers to not observe the blackened sections of the image and to optimize the 3D viewing experience. The next reflecting pixel joint blacked out pixel 83 does not vertically align with similar segments above and below it.

FIG. 4b is the pixel map in the same location as FIG. 4a after the rotating lenticular screen is advanced. As the reflecting lenticular dome advances forward in its physical rotation, the first reflecting lenticular at a second instance in time 35a together with a second reflective lenticular at a second instance in time 67a, a first reflecting lenticular joint at a second instance in time 71a, and a second reflecting lenticular joint at a second instance in time 81a all have advanced forward one pixel width. The first pixel at a second instance in time 34a of FIG. 3a now represents a different 3D image perspective than did first pixel at a first instance in time 34 and the first pixel at a second instance in time comprising color constituencies including a first red sub-pixel at a second time instance 61a, a first green sub-pixel at a second time instance 63a, and a first blue sub-pixel at a second time instance 65a. Similarly, the first black pixel at a second instance in time 73a and the second black pixel at a second instance in time 83a have advanced to match the position of the rotating reflecting lenticular joints. Thus the pixel map that is produced by the image processor and projected by the projector will comprise repeating series of pixel groups including a pixel from the first 3D perspective image, a pixel from the second 3D perspective image and so on until a pixel from the last 3D perspective image, then a black pixel will be presented in the map. In the succeeding image, the perspective represented by each pixel will be advanced one 3D perspective. Every pixel reflected from the surface will represent every viewing perspective throughout the cycle of a single reflecting lenticular passing by the pixel's point caused by it consistent trajectory throughout operation while the angle of the surface upon which it is incident.

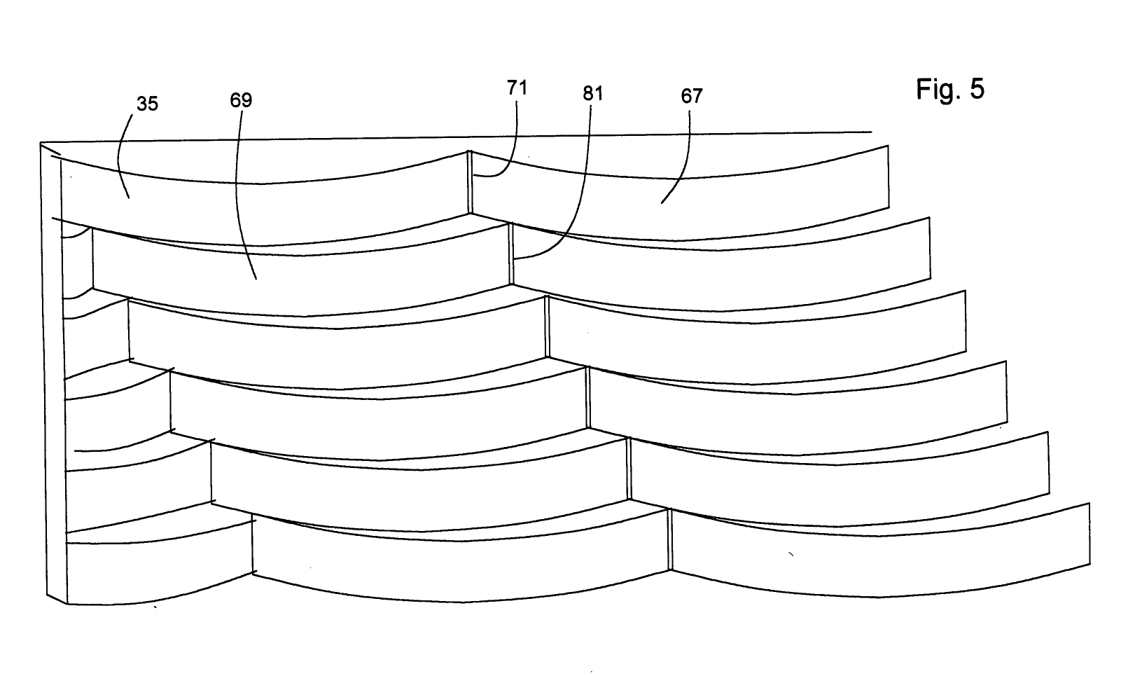

FIG. 5 illustrates a section of reflective lenticular rotating 3D pixel array. A second row first reflecting lenticular 69 is not aligned with the higher row including first reflecting lenticular at first time instance 35.

FIG. 6 illustrates an inside and bottom up view of the lenticular positioning of a 3D auto stereoscopic rotating dome screen. In applications where rotating structures have different circumferences across cross sections in a range of horizontal planes, such as does a dome and a conic section, the frequencies at which individual pixels can be turned on and off by lenticulars passing by vary in relationship to the circumference with smaller circumferences being turned on and off at a slower rate than larger circumferences assuming reflecting lenticular size and pixel size are maintained as constant through the differing circumferences. It is possible to use smaller pixels and smaller lenticular structures as rows get slower toward the dome peak for example to maintain the same 3D resolution as an alternate, the upper portion of the dome may contain just a blue sky with lower resolution or no 3D at all. In the later scenario, the true auto stereoscopic 3D images will be on the lower levels of the dome and the upper levels will portray less complex images. A similar phenomenon exists anytime objects with a range of horizontal cross section circumferences are rotated such as with domes and conic sections for example. As will be later discussed, rotating an object with consistent circumferences through its range of horizontal cross sections, such as the rotating cylinders later discussed, ensures that all pixels can be switched on and off at the same rate because they have the same number of lenticulars passing by and lend themselves to auto stereoscopic 3D across their entire inner or outer surfaces. As the reflecting lenticulars within the dome circumference in a lower plane such as the first reflecting lenticular at a first instance in time 35 rotates with sufficient speed to achieve lenticulars passing by each projected pixel at a rate of 60 hertz such as was calculated above, the rate at which lenticulars will pas by pixels in smaller circumferences in less than 60 hertz. A lenticular from a smaller horizontal cross section plane circumference 91 is part of a lesser number of lenticulars than is the first lenticular 35.

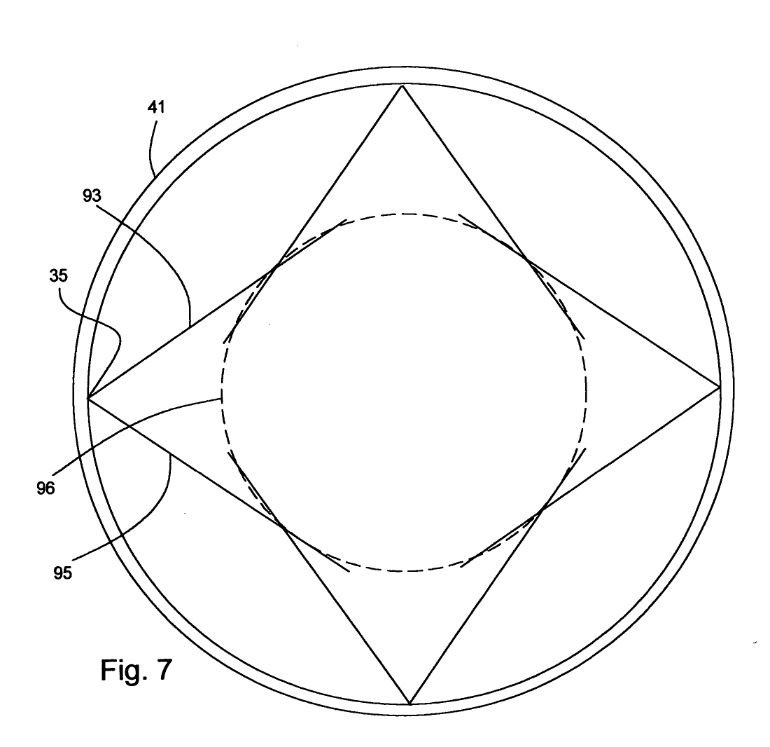

FIG. 7 illustrates a top view of the effective auto-stereoscopic viewing zone assuming 20 pixels per lenticular each reflected 3 degrees wide. Throughout its entire rotation, the first rotating lenticular at a first instance in time 35 will reflect light from the first pixel through a left most perspective 95 and a right most perspective 93. All pixels will similarly be reflected through a range from the left most perspective to the right most perspective such that a full auto stereoscopic viewing range 96 comprises a circle wherein one or more users within that circle will see auto stereoscopic 3D from every point on the surface of the rotating geometric structure.

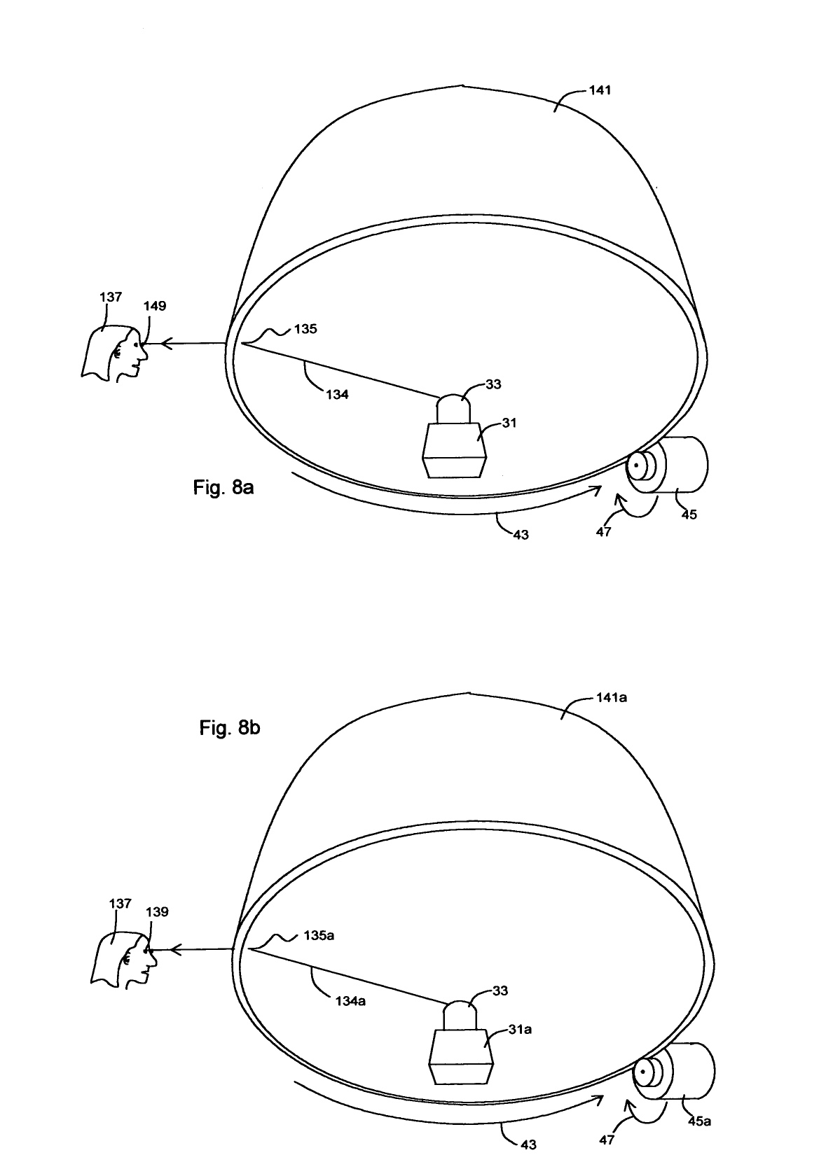

FIG. 8a illustrates a second embodiment of a rotating lenticular dome comprising a transmissive steering array with a user on the outside of the dome. A second rotating dome at a first instance 141 directs light to a user as previous described except that whereas the previous discussion described reflective lenticulars, the second rotating dome comprises a surface made of embossed transparent, light transmissive lenticular structures. Such transmissive lenticulars are will known in 3D applications and can be embossed or molded into the surface of a rigid transparent plastic dome shaped structure. A first transmissive lenticular at a first time instance 135 directs light from a first transmitted pixel at a first time instance 134 which is representative of a first transmitted perspective which is incident upon a left eye of a second user 149 of a second user 137. The discussion about shapes and characteristics in FIGS. 1a, 1b, 2, 3a, 3b, 3c, 3d, 4a, 4b, 5, 6, and 7 are germane to the art of FIG. 8a except that the lenticulars are transmissive in the later and reflective in the former.

FIG. 8b illustrates the system of FIG. 8a rotationally advanced at a subsequent time. A second transmissive dome at a second time instance 141a has been rotationally advanced by one pixel width. The incident pixel is now incident upon a first transmissive lenticular at a second time instance 135a such that a first transmissive pixel at a second time instance 134a is directed to a transmissive dome user's left eye 139 of the second user 137.

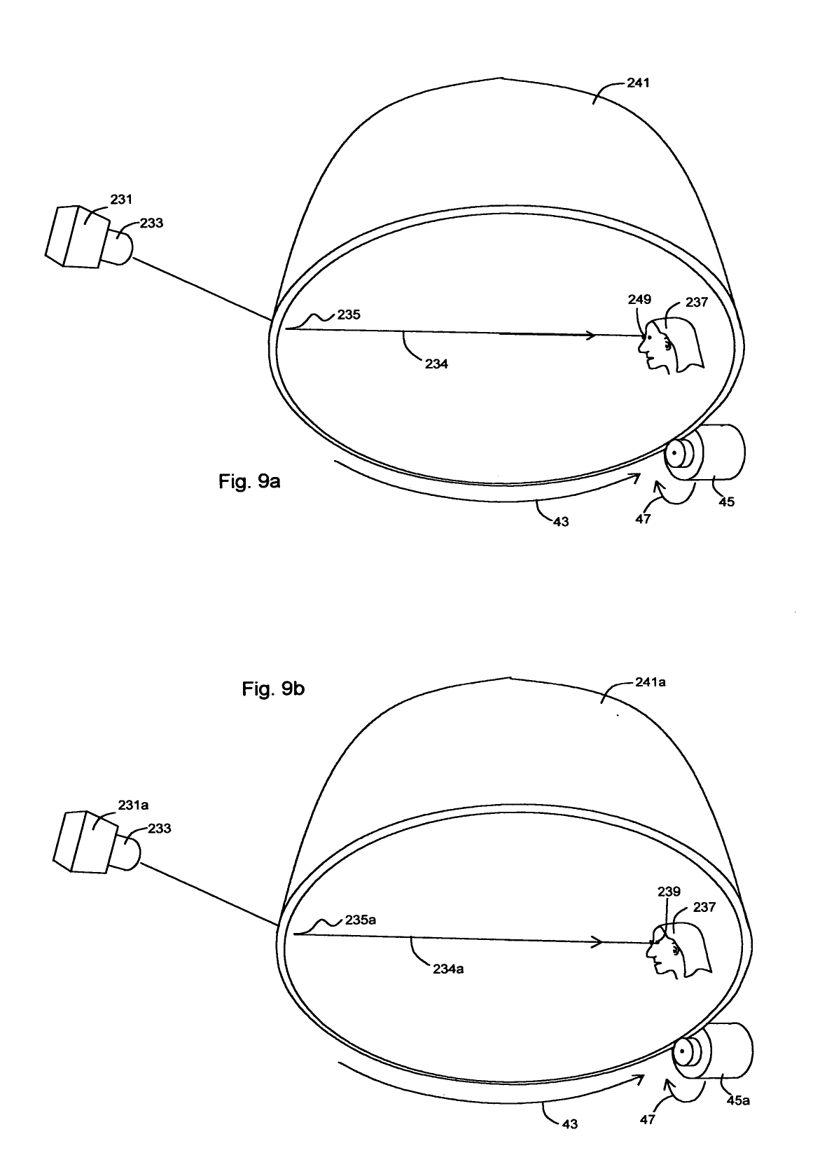

FIG. 9a illustrates a third embodiment of a rotating lenticular dome comprising a transmissive steering array with a user on the inside of the dome. A third rotating dome at a first instance 241 directs light to a user as previously described in FIGS. 8a and 8b except that whereas the previous discussion described a projector inside the dome's curtain, the present embodiment has the user inside the dome's curtain and the projector outside of the dome's curtain. Both domes comprise a surface made of embossed transparent, light transmissive lenticular structures. Such transmissive lenticulars are well known and can be embossed or molded into the surface of a rigid transparent plastic dome shaped structure. A first outside-in transmissive lenticular at a first time instance 235 directs light from a first transmitted outside-in pixel at a first time instance 234 which is representative of a first transmitted perspective which is incident upon a right eye of a third user 249 of a third user 237. The discussion about shapes and characteristics in FIGS. 1a, 1b, 2, 3a, 3b, 3c, 3d, 4a, 4b, 5, 6, and 7 are germane to the art of FIG. 9a except that the lenticulars are transmissive in the later and reflective in the former. Also, whereas a projector lens and software made by Elumens for projecting onto dome surfaces was specified for FIGS. 1a, 1b, 8a, and 8b, a lens for projecting onto the exterior of a dome requires a pincushion shaped output and associated software, such lenses and software are known in the prior art. The transmissive rotating structures that utilize lenticulars do not require a truly diffuse surface but instead utilize surface structures that cause light to diverge vertically in a wide field but horizontally in a narrow field as is described in applications by the present applicant previously referenced and incorporated herein. As will be described later, in some applications, rotating structures may have truly light diffusing surfaces, for example as when a light filter replaces a lenticular structure.

FIG. 9b illustrates the system of FIG. 9a rotationally advanced at a subsequent time. A third transmissive dome at a second time instance 241a has been rotationally advanced by one pixel width. The incident pixel is now incident upon a first outside-in transmissive lenticular at a second time instance 235a such that a first transmissive outside-in pixel at a second time instance 234a is directed to a transmissive dome user's right eye 239 of the third user 237.

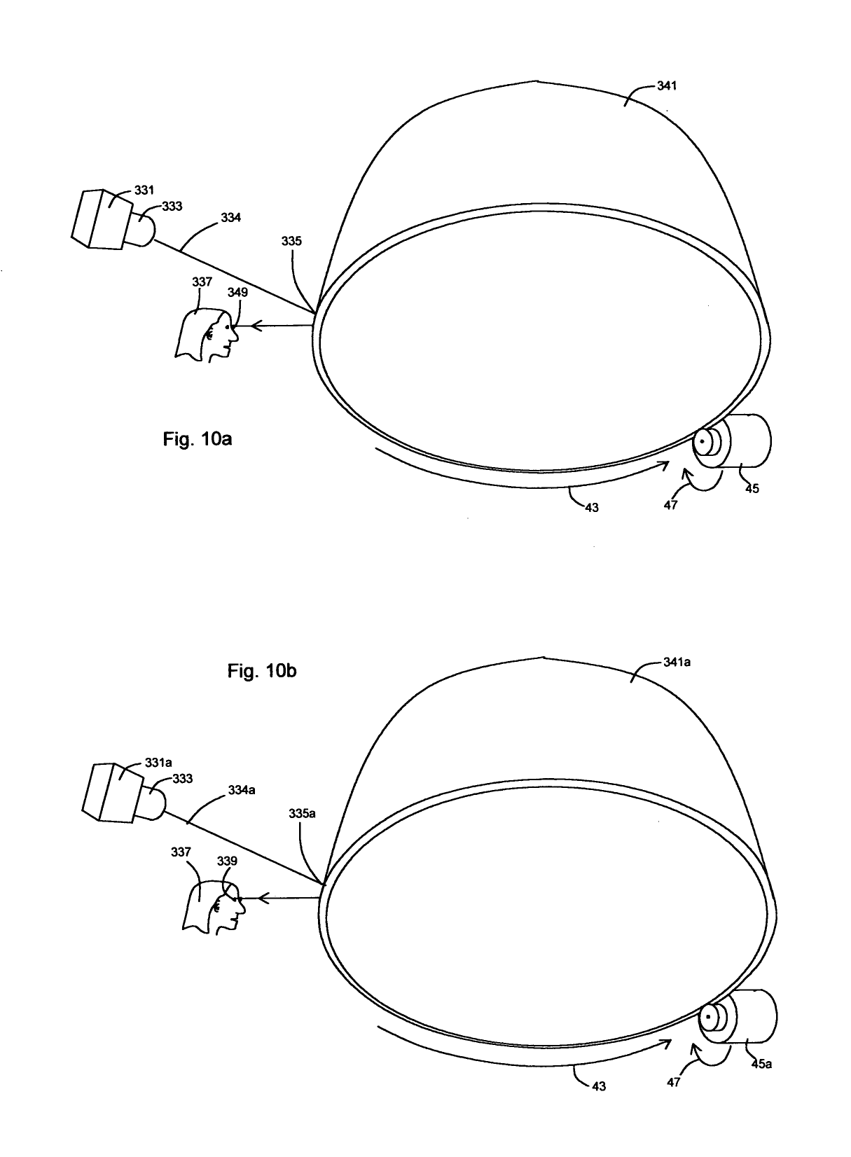

FIG. 10a illustrates a fourth embodiment of a rotating lenticular dome comprising a reflective steering array with a user on the outside of the dome. A fourth rotating dome at a first instance 341 directs light to a user as previously described in FIGS. 1a and 1b except that whereas the previous discussion described a projector and user inside the dome's curtain the present embodiment has the projector and user outside the dome's curtain. Both domes comprise a surface made of embossed reflective lenticular structures but whereas those in FIGS. 1a and 1b were on the interior of the dome, those in FIGS. 10a and 10b are on the exterior of the dome. Such reflective lenticulars are well known and can be embossed or molded into the surface of a rigid transparent plastic dome shaped structure. A first outside-out reflective lenticular at a first time instance 335 directs light from a first reflected outside-out pixel at a first time instance 334 which is representative of a first transmitted perspective which is incident upon a left eye of a fourth user 349 of a fourth user 337. The discussion about shapes and characteristics in FIGS. 1a, 1b, 2, 3a, 3b, 3c, 3d, 4a, 4b, 5, 6, and 7 are germane to the art of FIG. 9a except that the lenticulars are on outer surface of the rotating structure in the later and on the inside in the former. Also, the discussion of the projector lens and software of FIGS. 9a and 9b is also relevant to FIGS. 10a and 10b.

FIG. 10b illustrates the system of FIG. 8a rotationally advanced at a subsequent time. A fourth reflective dome at a second time instance 341a has been rotationally advanced by one pixel width. The incident pixel is now incident upon a first outside-out reflective lenticular at a second time instance 335a such that a first reflective outside-out pixel at a second time instance 334a is directed to a reflective dome user's right eye 339 of the fourth user 337.

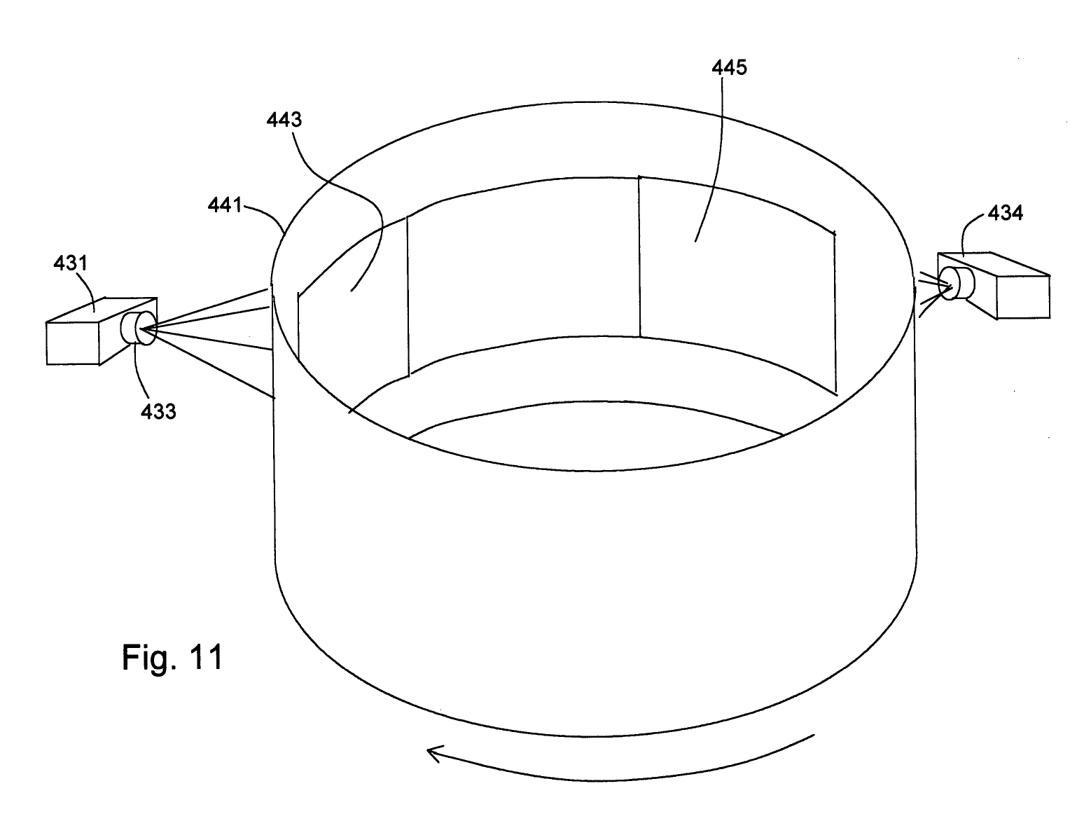

FIG. 11 illustrates a cylindrically shaped rotating pixel steering array which can be substituted for the domes described in previous Figures. The discussion relating to rotating domes of FIGS. 1a, through 10b are germane and directly applicable to rotating cylinders and other rotating structures such as conic sections but to avoid redundancy are not repeated for every conceivable shaped structure that could be rotated for steering pixels. For example an image creation means such as a projector can be inside the rotating pixel steering cylinder with the user also on the inside of the rotating pixel steering cylinder, an image creation means such as a projector can be inside the rotating pixel steering cylinder with the user on the outside of the rotating pixel steering cylinder, an image creation means such as a projector can be outside of the rotating pixel steering cylinder with the user on the inside of the rotating pixel steering cylinder, an image creation means such as a projector can be outside of the rotating pixel steering cylinder with the user on the outside of the rotating pixel steering cylinder. The rotating cylinders offering the advantage of have lenticulars rotating at a uniform speed through their entire surface area which avoids the challenges describe in FIG. 6. A plurality of projectors are used to create an auto stereoscopic 3D immersive environment inside a first rotating lenticular cylinder 441 including first cylinder projector 431 which incorporates first cylindrical projection lens 433. It should be noted that for a vary large cylinder where the curvature approaches that of a flat surface, a standard projection lens and operating software can be utilized. A second cylinder projector 434 projects a second image 445 which is steered through the non-diffusive transmissive lenticular array.

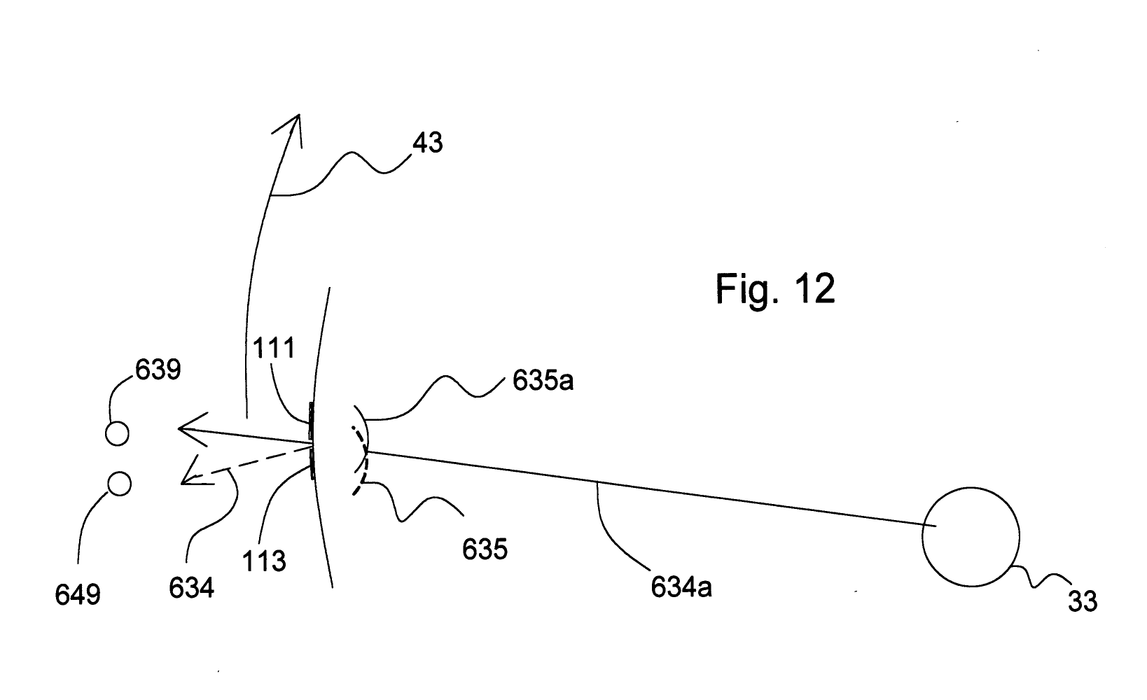

FIG. 12 illustrates a non-diffusing transmissive lenticular in combination with a light filter. A first filtered pixel at a second instance in time 643a steered by a rotating filtered lenticular at a second instance 635a to be directed to a rotating cylinder filtered lenticular display user filtered right eye 639. The right side of a first filter 111 and the left side of a first filter 113 absorbing light from the filtered pixel except in a narrow horizontal range including the user's right eye 639. A first filtered pixel at a first instance in time 643 steered by a rotating filtered lenticular at a first instance 635 to be directed to a rotating cylinder filtered lenticular display user's filtered left eye 649. The right side of a first filter 111 and the left side of a first filter 113 absorbing light from the filtered pixel except in a narrow horizontal range including the user's left eye 634.

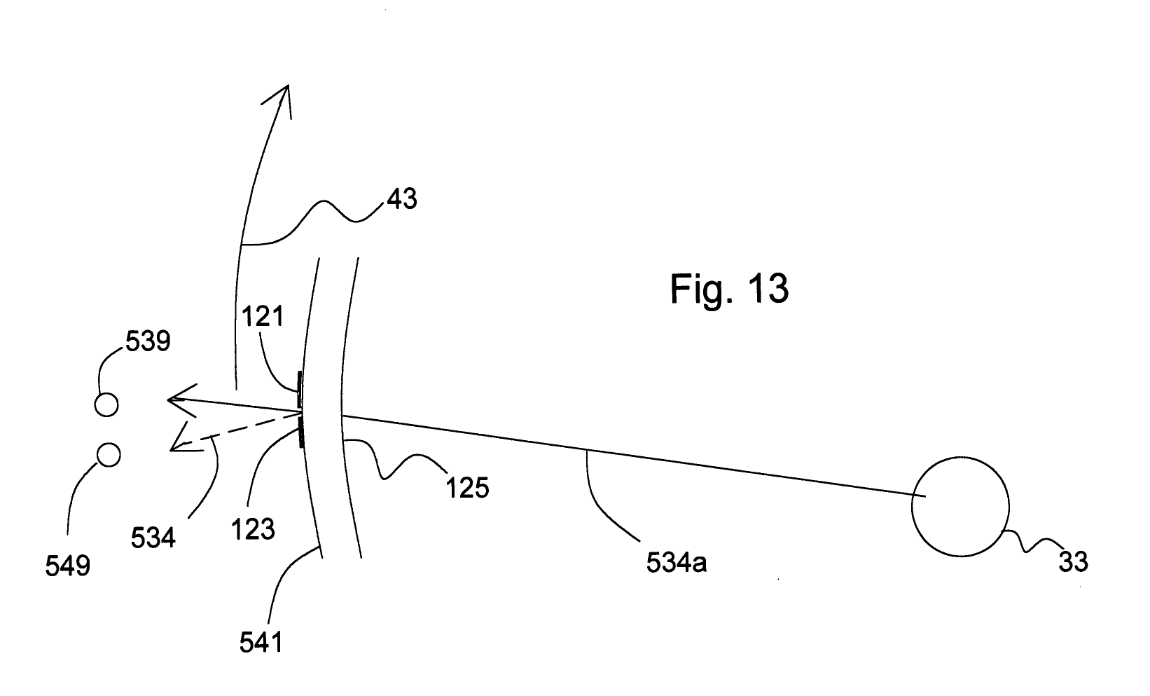

FIG. 13 illustrates a light diffusing cylinder surface in combination with a light filter. A second filtered pixel at a second instance in time 534a steered by a rotating filtered light diffusive cylinder at a second instance 125 to be directed to a rotating diffuse cylinder user's right eye 539. The right side of a second filter 121 and the left side of a second filter 123 absorbing light from the filtered pixel except in a narrow horizontal range including the user's right eye 539. A second filtered pixel at a first instance in time 534 steered by a rotating diffuse surface with filter array at a first instance to be directed to a rotating diffuse filtered cylindrical display user's left eye 549. The right side of the second filter and the left side of the second filter absorbing light from the filtered pixel except in a narrow horizontal range including the user's left eye 549. The filtered cylindrical displays of FIGS. 12 and 13 comprise many such filters directing many pixels concurrently each respectively representing the complete range of auto stereoscopic 3D image perspectives or alternately completely different programs or multiple concurrent image streams. In this respect, the rotating filter arrays present complete images to users similarly to the rotating transmissive and reflective lenticular arrays previously discussed.

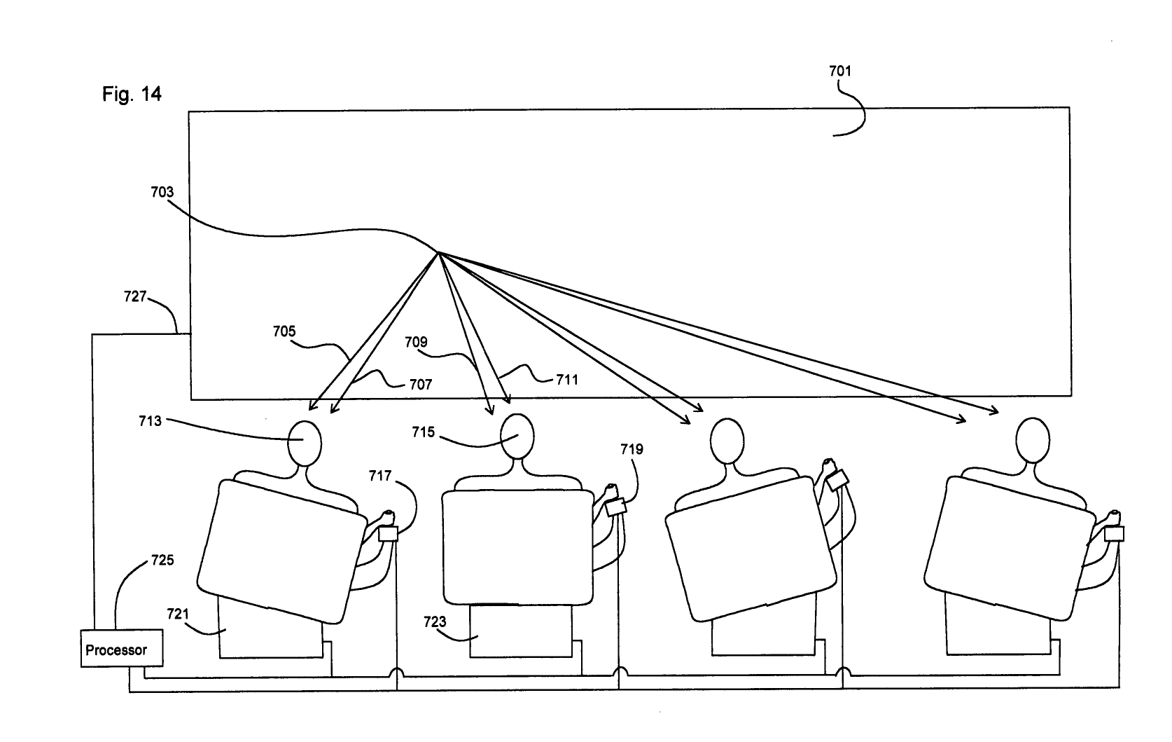

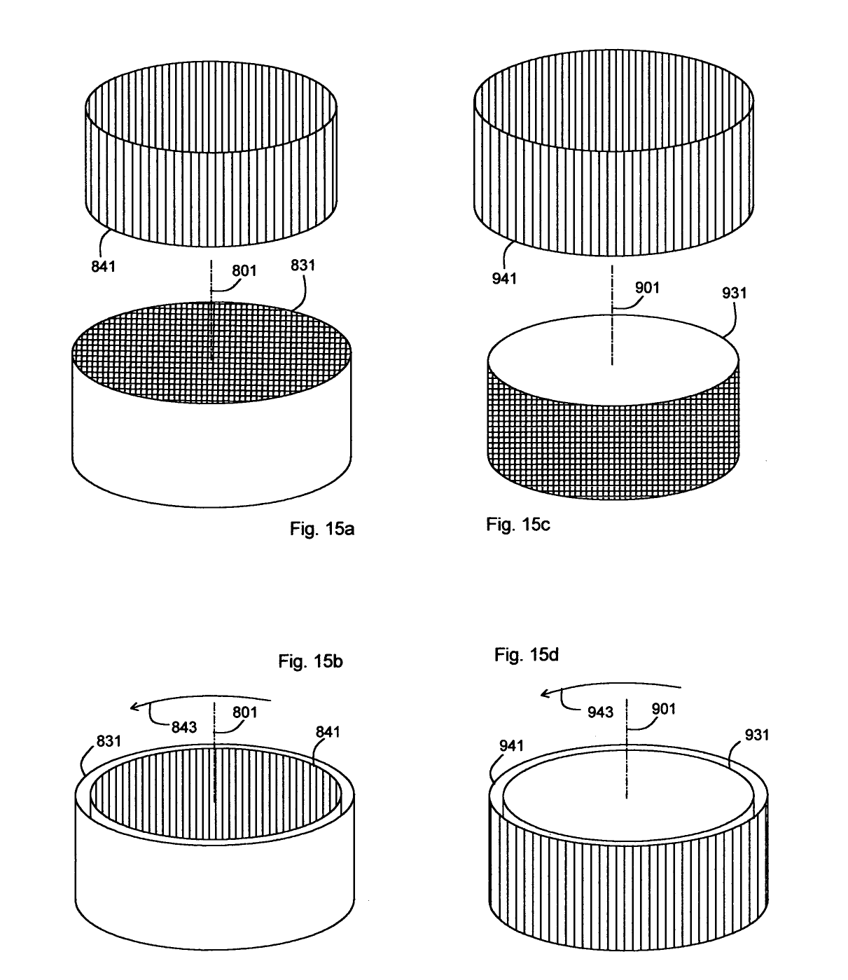

FIG. 14 illustrates multiple users interacting with an auto stereoscopic 3D and multiple program display. A 3D auto stereoscopic display screen 701 comprises a large number of pixels each representing a range of viewing perspective of the same or of completely different images. In practical application, such a display will enable a row of users that are in a range of distinct horizontal positions to each watch and as illustrated to interact with 3D environments that are completely distinct from one another. For example a first interactive display pixel 703 emits light representative of a first interactive user's first perspective 705 which is seen by a left eye of a first interactive user 713. The first interactive display pixel 703 also emits light representative of a first interactive user's second perspective 707 which is seen by a right eye of the first interactive user 713. Concurrently, or nearly concurrently, the first interactive display pixel 703 emits light representative of a second interactive user's first perspective 709 which is seen by a left eye of a second interactive user 715. The first interactive display pixel 703 also emits light representative of a second interactive user's second perspective 711 which is seen by a right eye of the first interactive user 715. Similarly, all of the users receive distinct left eye and right eye light from each pixel on the screen. Each respective user having a control such as first interactive user's control 717 and second interactive user's control 719 that enables each respective user to navigate independently through a common 3D environment or through completely different 3D environments. Each user sits in an interactive seat having independent actuators such as first interactive actuators 721 and second interactive actuators 723 such that the first user feels like she is interacting with a first feature of a 3D environment and is actuated to the right while the second interactive user is interacting with a flat environment and is actuated to the level position. Each of the user controls feeds electronic signals to a processor 725 which interprets the users' inputs as steering instructions that the processor uses to call up images representative of the 3D environment through which the user is navigating for presentation to an image generation mechanism 727 such as has been described previously in this application or is discussed in FIG. 15a and 15b. The processor also controls the actuators as a function of the user's input and the virtual environment. Video games with actuators and processors controlling images being known in the prior art. The present invention being one that enables multiple users to view discrete interactions on a common auto-stereoscopic display.

FIG. 15a illustrates a rotating transmissive lenticular array steering light from a light emitting array and viewable from inside the lenticular cylinder. The rotating lenticular integrated with a direct view type image generator has been previously described by the present applicant in U.S. application Ser. No. 11/095,403 filed Mar. 31, 2005 and is incorporated herein by reference. A first OLED display 831 is constructed to form a cylindrical shape such that light from individual pixels is emitted toward the center of the cylinder. Placed inside the OLED cylinder and is close proximity thereto is a cylindrical transmissive lenticular array 841 which is manufactured as previously described. The cylindrical OLED array and the cylindrical transmissive lenticular array each share a first center axis 801.

FIG. 15b illustrates the rotating transmissive lenticular array steering of FIG. 15a in operation. In operation, the inward facing OLED array is stationary while the inside transmissive lenticular array rotates around the first center axis 801 in a cylindrical array rotating motion 843. As described in multiple previous drawings herein, multiple users on the inside of this rotating lenticular array will experience auto stereoscopic 3D video streams.

FIG. 15c illustrates a rotating transmissive lenticular array steering light from a light emitting array and viewable from outside the lenticular cylinder. The rotating lenticular integrated with a direct view type image generator has been previously described by the present applicant in U.S. application Ser. No. 11/095,403 filed Mar. 31, 2005 and is incorporated herein by reference. A second OLED display 931 is constructed to form a cylindrical shape such that light from individual pixels is emitted away from the cylinder. Placed outside of the OLED cylinder is a second cylindrical transmissive lenticular array 941 which is manufactured as previously described. The cylindrical OLED array and the cylindrical transmissive lenticular array each share a second center axis 901.

FIG. 15d illustrates the rotating transmissive lenticular array steering of FIG. 15c in operation. In operation, the outward facing OLED array is stationary while the outside transmissive lenticular array rotates around the second center axis 901 in a second cylindrical array rotating motion 943. As described in multiple previous drawings herein, multiple users on the outside of this rotating lenticular array will experience auto stereoscopic 3D video streams or respective multiple 2D programs.

Operation of the Invention

Operation of the invention has been discussed under the above heading and is not repeated here to avoid redundancy.

### CONCLUSION, RAMIFICATIONS, AND SCOPE

Thus the reader will see that the Rotating Cylinder Multi-Program and Auto-stereoscopic 3D Display and Camera of this invention provides a novel unanticipated, highly functional and reliable means for producing multiple functionalities in a number of rotating geometric shaped pixel steering arrays. Each display comprising a rotating array element and an image generation means which together provide a cost effective auto stereoscopic display that also functions as a multiple program display and can play 2D media as well.

While the above description describes many specifications, these should not be construed as limitations on the scope of the invention, but rather as an exemplification of a preferred embodiment thereof. Many other variations are possible for example:

The prior related patent applications of the present applicant which are cross referenced herein also contain relevant information which is incorporated herein by reference but not repeated to avoid redundancy.

A mobile version of the present invention can be incorporated into a truck or trailer to be moved from place to place as an amusement ride or as a training simulator.

The present invention can be incorporated into and amusement park ride that moves on tracks or otherwise.

In the transmissive embodiments, the shape of the lenticulars can be convex or concave. Also, while refraction is described herein for directing light to desired portions of user space, diffraction can also be used.

In the reflective embodiments, the shape of individual reflectors can be concave or convex or may employ diffractive structures.

While the image creation described herein relies upon a DLP projector or and OLED display, other image generators can be substituted such as Cathode Ray Tubes (CRT), FEDs, Liquid Crystal Displays (LCD), OLEDs, PLEDs, Plasma, Lasers, LCoS, Digital Micromirror Devices (DMD), front projection, rear projection, or direct view in one way or another.

The rotating optical structures herein are integrated with an image generation means. In another embodiment, image generation means can be replaced by an image receiving means which when integrated with the described rotating optical structures comprise an auto stereoscopic 3D video camera.

What is claimed:

1. A display screen adopted for displaying at least one type of media selected from the group consisting of; stereoscopic 3D media, auto stereoscopic 3D media, at least two concurrent 3D content streams, and at least two concurrent 2D content streams, comprising:
a light emitter for formulating an image,
a light modulator comprising a rotating geometric structure having a generally circular cross section in a plane perpendicular to its axis of rotation and comprising a plurality of image light steering elements selected from the group consisting of light reflectors, transmissive optics, light filters,
and wherein a user looking at a segment of the rotating geometric structure sees a first pixel representative of a first 3D perspective with her right eye and sees a second pixel representative of a second 3D perspective with her left eye.

2. The display screen of claim 1 wherein the user's eyes are generally in a plane which is perpendicular to the axis of rotation.

3. The display screen of claim 1 wherein the view of the user comprises an image inside said circular cross section

4. The display screen of claim 1 wherein said image producer comprises at least one projector.

5. The display screen of claim 1 wherein said light emitter has a relationship with said first pixel which is selected from the group consisting of; said light emitter is within the geometric curtain of said rotating structure and said pixel is viewable inside the geometric curtain of said rotating structure, said light emitter is within the geometric curtain of said rotating structure and said pixel is viewable outside the geometric curtain of said rotating structure, said light emitter is outside of the geometric curtain of said rotating structure and said pixel is viewable inside the geometric curtain of said rotating structure, and said light emitter is outside of the geometric curtain of said rotating structure and said pixel is viewable outside the geometric curtain of said rotating structure.

6. The display screen of claim 1 wherein at an instance in time, individual pixels comprising said image are shaped by the light steering elements to cover both a long vertical cross section and a narrow horizontal cross section of user space.
